(19) United States
(12) Patent Application Publication
(10) Pub. No.: US 2025/0216141 A1
(43) Pub. Date: Jul. 3, 2025

(54) Cooler Device

(71) Applicant: Melanie Haystrick, Strongsville, OH (US)

(72) Inventor: Melanie Haystrick, Strongsville, OH (US)

(21) Appl. No.: 18/983,985

(22) Filed: Dec. 17, 2024

Related U.S. Application Data
(60) Provisional application No. 63/615,528, filed on Dec. 28, 2023.

(51) Int. Cl. F25D 3/06; B43L 1/04

(52) U.S. Cl. CPC F25D 3/06; B43L 1/04; F25D 2303/081

(57) ABSTRACT

The device is comprised of a cooler body designed for variable size and capacity, optimized with insulating materials for effective temperature retention. The body incorporates at least one drain valve for liquid removal, optional wheels suited for diverse terrains, and a variety of handle types to support portability. The lid, attached via durable hinges, is similarly insulated and features a locking mechanism for security. Additionally, the lid or body may include a writing surface or a transparent receiving area, which holds and protects indicia-bearing cards for easy identification. The writing surface can be permanently or removably attached, allowing user customization, while the receiving area is UV-resistant to preserve card information.

### CROSS-REFERENCE TO RELATED APPLICATION

The present application claims priority to, and the benefit of, U.S. Provisional Application No. 63/615,528, which was filed on Dec. 28, 2023, and is incorporated herein by reference in its entirety.

### FIELD OF THE INVENTION

The present invention relates generally to the field of coolers. More specifically, the present invention relates to a cooler device with a writing surface and or receiving area that receives a card that allows a user to write or label the owner and/or contents of the device. Accordingly, the present disclosure makes specific reference thereto. Nonetheless, it is to be appreciated that aspects of the present invention are also equally applicable to other like applications, devices, and methods of manufacture.

### BACKGROUND

People commonly use ice chests or coolers to transport and store food, beverages, and other items that need to be kept cold during travel, outdoor activities, or gatherings. However, without a method to easily identify the cooler's contents from the outside, users are forced to open the lid, allowing cold air to escape and warm air to enter, which reduces the efficiency of the cooler. Once opened, they must reach into the ice, feeling around and potentially disturbing other items to identify what they are looking for. This process can be inconvenient, especially when the cooler is full, and results in temperature fluctuations that shorten the cooling duration.

Attempting to label a cooler by taping a piece of paper is often ineffective and visually unappealing. Further, the tape tends to lose its adhesiveness in wet or humid conditions, causing the label to fall off, and the paper can become soggy and unreadable over time. Additionally, many coolers on the market have similar appearances, particularly when they are the same brand or model. This similarity can lead to mix-ups where people mistakenly identify the wrong cooler as theirs, resulting in items being taken unintentionally and creating frustration or inconvenience for both parties.

Therefore, there exists a long-felt need in the art for an improved cooler. There also exists a long-felt need in the art for a cooler device that provides a cooler than can be easily identified. More specifically, there exists a long-felt need in the art for a cooler device that provides a cooler than can be easily identified via durable and customizable external labeling. In addition, there exists a long-felt need in the art for a cooler device that provides a cooler wherein the contents of the cooler can be easily identified via durable and customizable external labeling

The subject matter disclosed and claimed herein, in one embodiment thereof, comprises a cooler device. The device is comprised of a cooler body designed for variable size and capacity, optimized with insulating materials for effective temperature retention. The body incorporates at least one drain valve for liquid removal, optional wheels suited for diverse terrains, and a variety of handle types to support portability. The lid, attached via durable hinges, is similarly insulated and features a locking mechanism for security. Additionally, the lid or body may include a writing surface or a transparent receiving area, which holds and protects indicia-bearing cards for easy identification. The writing surface can be permanently or removably attached, allowing user customization, while the receiving area is UV-resistant to preserve card information.

In this manner, the cooler device of the present invention accomplishes all the foregoing objectives and provides an improved cooler that can be easily identified. More specifically, the device provides a cooler that can be easily identified via durable and customizable external labeling. In addition, the provides a cooler wherein the contents of the cooler can be easily identified via durable and customizable external labeling

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cooler device. The device comprises a cooler body designed in various sizes and shapes to accommodate different user needs, from small personal coolers to larger, multi-gallon capacities. Constructed from insulated materials, including polyurethane foam, EPS, or vacuum-sealed panels, the body ensures effective temperature retention and may feature UV-resistant properties to enhance durability.

The cooler body includes at least one drain valve for easy removal of melted ice or liquids, which may utilize twist, lever, or button activation. Additionally, the body features one or more handles and wheels, with handles available in styles such as molded grips, retractable designs, or reinforced rope handles. Wheels are available in different types and sizes to suit various terrains, such as rubberized wheels for smooth surfaces or all-terrain options for sand, grass, or rocky paths.

The cooler includes at least one lid connected to the body with durable hinges, such as stainless steel or high-impact plastic, facilitating smooth operation. The lid is insulated to maintain temperature and can be secured with one or more locking mechanisms, including latches, clamps, or padlocks, made from sturdy materials like stainless steel or reinforced plastic.

The lid or other exterior surfaces may feature a writing surface, allowing users to mark ownership or contents. This surface may be dry-erase, chalkboard, or similar, and can be either permanently or removably attached to the lid with fasteners like magnetic strips or hook-and-loop closures, providing options for customization or replacement.

In another embodiment, the lid may include a transparent receiving area for a card displaying information about the cooler's contents or owner. This area is UV-treated and weather-resistant to protect the card, which may be made from durable materials like laminated or synthetic waterproof paper and include printed or handwritten indicia.

Accordingly, the cooler device of the present invention is particularly advantageous as it provides an improved cooler that can be easily identified. More specifically, the device provides a cooler that can be easily identified via durable and customizable external labeling. In addition, the provides a cooler wherein the contents of the cooler can be easily identified via durable and customizable external labeling. In this manner, the cooler device overcomes the limitations of existing coolers known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a cooler device of the present invention while closed in accordance with the disclosed architecture; and

FIG. 2 illustrates a perspective view of one potential embodiment of a cooler device of the present invention while closed, wherein the writing surface is not attached to the lid while closed in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved cooler. There also exists a long-felt need in the art for a cooler device that provides a cooler than can be easily identified. More specifically, there exists a long-felt need in the art for a cooler device that provides a cooler than can be easily identified via durable and customizable external labeling. In addition, there exists a long-felt need in the art for a cooler device that provides a cooler wherein the contents of the cooler can be easily identified via durable and customizable external labeling

The present invention, in one exemplary embodiment, is comprised of a cooler device. The device includes a cooler body available in various sizes and shapes, suitable for diverse user needs, from compact personal coolers to larger, multi-gallon options. The body is constructed from insulated materials, such as polyurethane foam, EPS, or vacuum-sealed panels, to ensure effective temperature retention and may include UV-resistant properties for enhanced durability.

The cooler body incorporates at least one drain valve to facilitate easy drainage of melted ice or liquids, utilizing twist, lever, or button mechanisms. It also features one or more handles and wheels, with handles available in styles like molded grips, retractable types, or reinforced rope handles. Wheels are designed for different terrains, with rubberized wheels for smooth surfaces and all-terrain options for sand, grass, or rocky paths.

The cooler includes at least one lid, attached to the body with durable hinges, such as stainless steel or high-impact plastic, allowing smooth operation. The lid is insulated to maintain temperature and may be secured with one or more locking mechanisms, including latches, clamps, or padlocks, made from robust materials like stainless steel or reinforced plastic.

The lid or other exterior surfaces may feature a writing surface, enabling users to mark ownership or contents. This surface may be dry-erase, chalkboard, or similar, and can be permanently or removably attached to the lid with fasteners like magnetic strips or hook-and-loop closures, allowing for customization or replacement.

In another embodiment, the lid may feature a transparent receiving area for a card displaying information about the cooler's contents or owner. This receiving area is UV-treated and weather-resistant, protecting a card made from durable materials, such as laminated or synthetic waterproof paper, which may include printed or handwritten indicia.

This cooler device offers the advantage of easy identification through durable and customizable external labeling, allowing clear identification of both ownership and contents, thereby overcoming limitations in existing coolers.

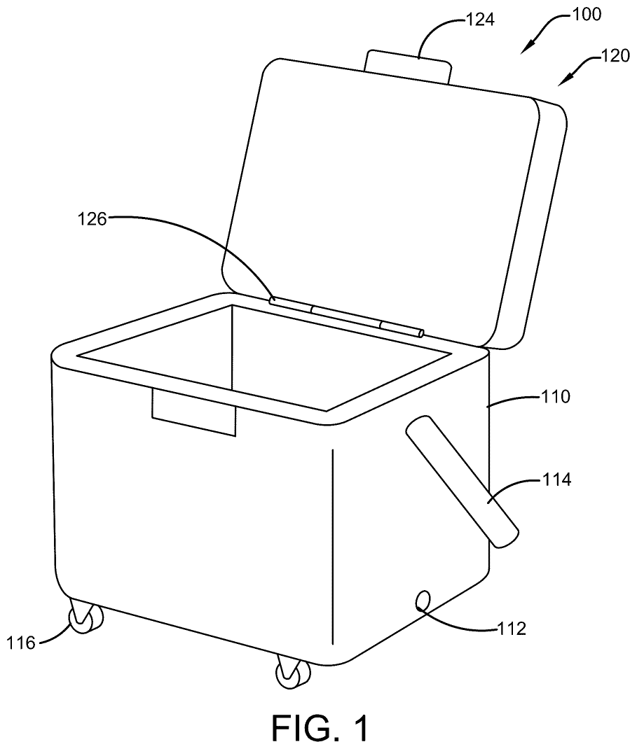

Referring initially to the drawings, FIG. 1 illustrates a perspective view of one potential embodiment of a cooler device 100 of the present invention while closed in accordance with the disclosed architecture. The device 100 is comprised of a cooler body 110, which can vary in size, shape, and configuration to accommodate different user preferences and capacity requirements, ranging from compact, personal sizes intended for individual use to large, multi-gallon capacities suitable for group activities or commercial use. The body 110 is comprised of high-grade insulating materials, including, but not limited to, polyurethane foam, expanded polystyrene (EPS), vacuum-sealed panels, or high-density polyethylene, each selected to optimize temperature retention by minimizing thermal transfer between the cooler's internal and external environments. The body 110 may also be made from or have a UV-resistant outer layer or coating to protect the materials against prolonged sun exposure, preventing material degradation and maintaining the cooler's durability over time. The body 110 is further comprised of at least one drain valve 112 strategically positioned at the lowest point of the interior base to facilitate efficient drainage of melted ice or other liquids without requiring tilting. The drain valve 112 may be configured with a twist, lever, or button-activated mechanism, each design enabling controlled and spill-resistant drainage.

The body 110, and in certain embodiments, the lid 120, may also include at least one handle 114. The handle 114 may vary in style, including molded grips for ergonomic handling, retractable handles for compact storage, or rope handles with reinforced anchors for flexibility in carrying. Additionally, the body 110 may be comprised of at least one wheel 116, with wheel types and diameters selected based on intended use and terrain. Smaller rubberized wheels may be suited for smoother surfaces, while larger, rugged all-terrain wheels with enhanced treads can enable smoother movement over sand, grass, or rocky surfaces.

The body 110 is comprised of at least one lid 120 that provides a secure closure to preserve the internal temperature. The lid 120 is preferably connected to the body 110 through at least one hinge 126, which may include durable options such as stainless steel, high-impact plastic, or corrosion-resistant metal hinges, ensuring reliable and smooth operation during repeated use. The lid 120 is comprised of the same or similar insulating materials as the body 110 to maintain a consistent thermal barrier, minimizing temperature loss. To secure the lid 120 to the body 110, at least one locking mechanism 124 may be included. The locking mechanism 124 can comprise latches, clamps, cam locks, or additional security features like a key lock or padlock.

A top surface 121 of the lid 120, or any exterior/interior surface of the lid 120, may be comprised of at least one writing surface 130. The writing surface 130 can be configured as a dry-erase surface, chalkboard, or similar writable material, allowing users to add indicia 152 to the lid 120. This feature enables clear identification of ownership, contents, or other pertinent information relevant to the device's 100 use, making it especially advantageous in shared environments or for easy labeling in commercial settings.

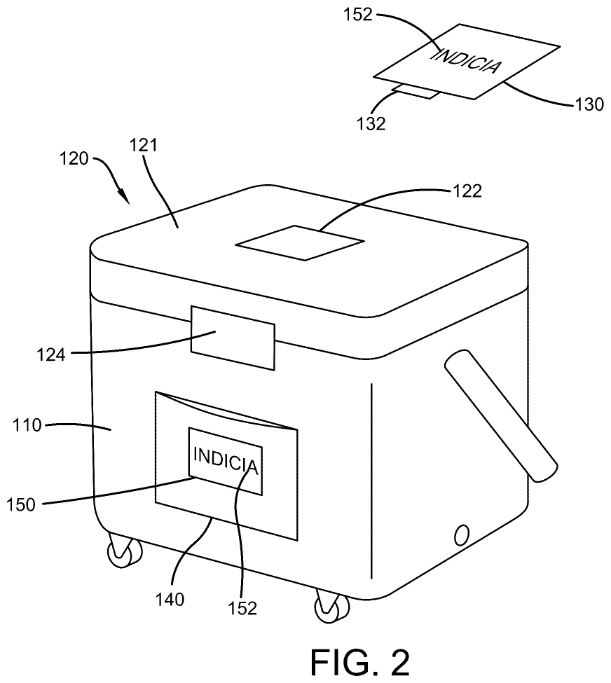

In one embodiment, the writing surface 130 is fixedly attached to the lid 120. In another embodiment, the writing surface 130 is designed for removability, allowing it to be detached and replaced as needed. This removable design is facilitated by at least one pair of reciprocating fasteners 122, 132, which may include magnetic strips, snap buttons, or hook-and-loop fasteners, each offering a secure yet detachable connection, as seen in FIG. 2. Such a design permits users to customize or replace the writing surface 130 to match changing needs or to update information easily.

In an alternative embodiment, the lid 120 may incorporate at least one receiving area 140, intended to function as a visible, protected slot for storing at least one informational card 150. The receiving area 140 may be comprised of a transparent, UV-resistant plastic sleeve integrated into the lid 120, ensuring clear visibility and protection for any inserted card 150. The material of the receiving area 140 may also be water-resistant to further protect inserted items from environmental exposure, preserving the readability of the information over extended use.

The card 150, designed to fit within the receiving area 140, may be comprised of durable, weather-resistant materials, including laminated paper, plastic, or synthetic waterproof paper, ensuring resilience against moisture and wear. The card 150 is intended to include at least one indicia 152, which may comprise printed, handwritten, or stamped information in the form of words, symbols, or images to identify the cooler's owner, usage instructions, or contents. This flexible format allows users to personalize the cooler for individual or organizational needs, improving convenience and usability.

It should be appreciated that the writing surface 130 and receiving area 140 may be positioned not only on the lid 120 but also on alternative or additional locations on the body 110, providing versatility in placement based on user preferences. Furthermore, the surface 130 and area 140 (and any other associated structures/components) may be situated on any internal or external surface of the lid 120 and/or body 110, allowing users to access or display information from various orientations or cooler configurations.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cooler device” and “device” are interchangeable and refer to the cooler device 100 of the present invention.

Notwithstanding the foregoing, the cooler device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cooler device 100 as shown in the FIGS. are for illustrative purposes only, and that many other sizes and shapes of the cooler device 100 are well within the scope of the present disclosure. Although the dimensions of the cooler device 100 are important design parameters for user convenience, the cooler device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cooler device comprising:
a cooler body comprised of an insulating material and a drain valve;
a lid attached to the cooler body, the lid comprised of the insulating material; and
a writing surface positioned on the lid.

2. The cooler device of claim 1, wherein the writing surface is comprised of a dry-erase surface.

3. The cooler device of claim 1, wherein the writing surface is comprised of a chalkboard surface.

4. The cooler device of claim 1, wherein the lid is comprised of a handle.

5. The cooler device of claim 1, wherein the body is comprised of a handle.

6. The cooler device of claim 1, wherein the lid is comprised of a wheel.

7. A cooler device comprising:
a cooler body comprised of an insulating material and a drain valve;
a lid attached to the cooler body, the lid comprised of the insulating material;
a locking mechanism; and
a writing surface removably attached to the lid.

8. The cooler device of claim 7, wherein the lid attaches to the cooler body via a hinge.

9. The cooler device of claim 7, wherein the locking mechanism is comprised of a latch, a clamp, a cam lock, a key lock, or a padlock.

10. The cooler device of claim 7, wherein the cooler body is comprised of a UV-resistant material.

11. The cooler device of claim 7, wherein the cooler body is comprised of a polyurethane foam, an expanded polystyrene (EPS), a vacuum-sealed panel, or a high-density polyethylene.

12. The cooler device of claim 7 further comprised of a wheel.

13. The cooler device of claim 7, wherein the writing surface is comprised of a first fastener.

14. The cooler device of claim 13, wherein the lid is comprised of a second fastener.

15. The cooler device of claim 14, wherein the first fastener and the second fastener are comprised of a pair of reciprocating fasteners.

16. A cooler device comprising:
a cooler body comprised of an insulating material and a drain valve;
a lid attached to the cooler body, the lid comprised of the insulating material; and
a receiving area; and
a card comprised of an indicia.

17. The cooler device of claim 16, wherein the receiving area is positioned on the body.

18. The cooler device of claim 16, wherein the receiving area is positioned on the lid.

19. The cooler device of claim 16, wherein the receiving area is comprised of a transparent plastic sleeve.

20. The cooler device of claim 16, wherein the indicia is comprised of a word, a symbol, or an image.
